(19) United States
(12) Patent Application Publication
(10) Pub. No.: US 2010/0239828 A1
(43) Pub. Date: Sep. 23, 2010

(54) RESISTIVELY HEATED SMALL PLANAR FILAMENT

(76) Inventors: Sterling W. Cornaby, Springville, UT (US); Erik C. Bard, Lehi, UT (US)

Correspondence Address: THORPE NORTH & WESTERN, LLP., P.O. Box 1219, SANDY, UT, 84091-1219, US

(21) Appl. No.: 12/407,457

(22) Filed: Mar. 19, 2009

(51) Int. Cl. B32B 3/10

(52) U.S. Cl. 428/195.1

(57) ABSTRACT

A planar filament comprising two bonding pads and a non-linear filament connected between the two bonding pads. The filament may be wider in the center to increase filament life. The planar filament may be mounted on a substrate for easier handling and placement. Voltage can be used to create an electrical current through the filament, and can result in the emission of electrons from the filament. The planar filament can be utilized in an x-ray tube.

### FIELD OF THE INVENTION

The present invention relates to filaments used for electron emission or production of light.

### BACKGROUND

Filaments are used to produce light and electrons. For example, in an x-ray tube, an alternating current heats a wire filament formed in a coiled cylindrical or helical loop. Due to the high temperature of the filament, and due to a large bias voltage between the filament and an anode, electrons are emitted from the filament and accelerated towards the anode. These electrons form an electron beam. The location where the electron beam impinges on the anode is called the “electron spot”. It is often desirable that this spot be circular with a very small diameter. It is also often desirable that this spot be in the same location on the anode in every x-ray tube that is manufactured.

The shape and placement of the filament in the x-ray tube affects the shape of the spot. Some filaments are very small, especially in portable x-ray tubes. Placing such small filaments, in precisely the same location, in every x-ray tube, is a significant manufacturing challenge. Lack of precision of filament placement during manufacturing results in an electron spot that is in different locations on the anode in different x-ray tubes. Placement of the filament also affects spot size and shape. Lack of precision of filament placement also results in non-circular spots and spots that are larger than desirable.

With a wire filament 130 formed in a coiled cylindrical or helical loop, as shown in FIG. 13, as the filament heats and cools, the filament can bend and change its shape, as shown in FIG. 14. As the filament changes shape, the electron spot can change both location and size. This results in variability of x-ray tube performance over time. Also, the coiled cylindrical or helical shape of the filament can result in non-circular electron spots.

In addition, a filament wire, with a consistent wire diameter, can be hottest at the mid-point 131 along the length of the wire. If there is a consistent wire diameter, the voltage drop or power loss is consistent along the wire, resulting in the same heat generation rate along the wire. The connections at the ends of the wire 132, however, essentially form a heat sink, allowing more heat dissipation, and cooler temperatures, at the each end of the wire. The mid-point of the wire 131 loses less heat by conduction than the wire ends and can be the hottest location on the filament wire. This high heat can result in more rapid deterioration at the wire mid-point 131. As this center section deteriorates, its diameter decreases, resulting in a larger power loss, higher temperatures, and an even greater rate of deterioration at this location. Due to the higher temperatures and more rapid wire deterioration at the center of the filament wire, most failures occur at this location. Such failures result in decreased tube life and decreased tube reliability.

### SUMMARY OF THE INVENTION

It has been recognized that it would be advantageous to provide a filament which is easier to handle during manufacturing, resulting in more precise and repeatable placement of the filament. Increased precision of filament placement results in less performance variability between devices using these filaments. In addition, it has been recognized that it would be advantageous to provide a filament that maintains its shape during use and which is less susceptible to filament failures. In addition, it has been recognized that it would be advantageous to provide a smaller and more circular electron spot size in an x-ray tube. This smaller and more circular spot size can be in part the result of a filament which is manufactured and placed with high precision. In addition, it has been recognized that it would be advantageous to emit electrons or light from a two dimensional plane, rather than a three dimensional object, such as a coiled cylindrical or helical filament. This allows for increased ease in electron or light beam shaping, where both over-focusing and under-focusing are avoided because the planar filament is spatially constrained to two dimensions.

The present invention is directed to a planar filament device with a layer patterned to form: 1) a pair of spaced-apart bonding pads each configured to receive an electrical connection; and 2) a filament connected between the pair of bonding pads configured to receive an applied electric current through the bonding pads and filament.

In accordance with another aspect of the present invention, the planar filament can be associated with an x-ray tube with a vacuum enclosure; a cathode coupled to the vacuum enclosure; and an anode coupled to the vacuum enclosure and opposing the cathode.

### BRIEF DESCRIPTION OF THE DRAWINGS

FIG. 1 is a top view of a planar filament in accordance with one embodiment of the present invention;

FIG. 2 is a cross-sectional side view of a planar filament in accordance with another embodiment of the present invention;

FIG. 3 is a top view of another planar filament in accordance with another embodiment of the present invention;

FIG. 4 is a cross-sectional side view of a planar filament in accordance with another embodiment of the present invention;

FIG. 5 is a top view of a planar filament during the manufacturing process;

FIG. 6 is a top view of another planar filament in accordance with another embodiment of the present invention;

FIG. 7 is a top view of another planar filament in accordance with another embodiment of the present invention;

FIG. 8 is a top view of another planar filament in accordance with another embodiment of the present invention;

FIG. 9 is a top view of another planar filament in accordance with another embodiment of the present invention;

FIG. 10 is a top view of another planar filament in accordance with another embodiment of the present invention;

FIG. 11a is a photograph showing the top view of one embodiment of a planar filament;

FIG. 11b is a photograph showing the top view of one embodiment of a planar filament;

FIG. 12 is a schematic side view of an x-ray tube in accordance with the present invention with the planar filament of FIG. 1;

FIG. 13 is a top view of a prior art helical filament; and

FIG. 14 is a top view of a deformed prior art helical filament.

### DETAILED DESCRIPTION

Reference will now be made to the exemplary embodiments illustrated in the drawings, and specific language will be used herein to describe the same It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

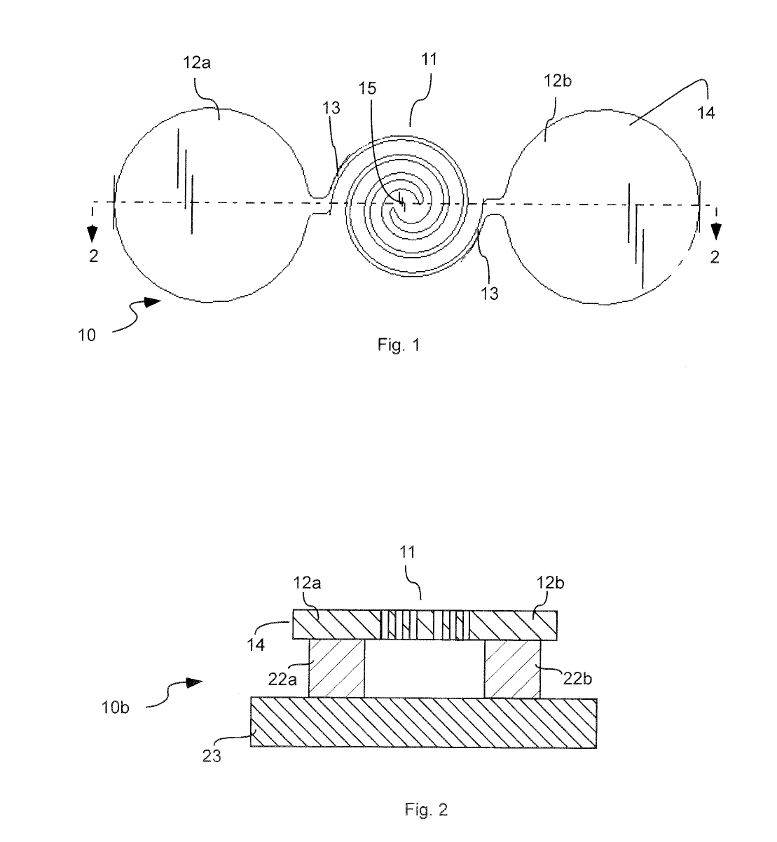

Referring to FIG. 1, a planar filament 10 in accordance with an exemplary embodiment of the present invention is shown. Two bond pads 12a and 12b are connected by a filament 11. The filament 11 can be sized and shaped to heat or otherwise emit electrons. The filament can include a material that is electrically conductive and configured to heat or otherwise emit electrons. Refractory materials such as tungsten containing materials, hexaboride compounds, or hafnium carbide may be used as filament materials. The bond pads may be made of the same material as the filament or may be a separate material. The filament 11 can be planar, or substantially flat, with a flat top and a flat bottom, and with upper and lower surfaces that are substantially parallel. The filament can have a width (taken parallel with the layer and transverse to the length of the filament) that is greater than a thickness of the filament.

The filament 11 can extend non-linearly between the pair of bonding pads 12a and 12b so that the filament has a length (if stretched linearly) longer than a distance between the bonding pads. The filament 11 can have a double spiral-shape oriented parallel with the layer, and which is connected at each end to a bonding pad 12a and 12b. In addition, the filament 11 can have a non-uniform width (taken parallel with the layer and transverse to the length of the filament). Thus, an intermediate portion, such as a middle 15 or center portion, of the filament can be wider while ends 13 of the filament can be narrower near the bonding pads. This results in a wider cross-sectional area for electrical current flow, and thus less electrical power generation and heat generation at the filament center than at other sections of the filament. With this wider cross-sectional area at an intermediate portion of the filament, the temperature in this area can be less than if the filament width were the same across the entire filament. This can result in reduced failures at the filament center and a longer average filament life. The change in filament width can result in more consistent temperatures along the length of the filament. This can also result in more even electron emission along the length of the filament and improved electron spot shape.

The filament 11 and bond pads 12a and 12b can be a thin film material. To avoid handling damage to this thin film material during filament manufacturing and placement, the planar filament can be connected to a type of support structure. A support structure which electrically isolates one bond pad 12a from the other bond pad 12b can be used to allow an electrical current to flow from one bond pad to the other through the filament. The support structure can be situated such that it does not touch the filament. This may be desirable in order to avoid conductive heat transfer from the filament to the support structure.

Referring to FIG. 2 a planar filament 10b, can be supported by electrically isolated support structures 22a and 22b. An electrical connection can be made directly to the bond pads 12a and 12b, with a different electrical potential on one bond pad 12a than on the other bond pad 12b, thus allowing an electrical current to flow through filament 11. Alternatively, if the support structures 22a and 22b are electrically conductive, an electrical connection can be made to the support structures, with a different electrical potential on one support structure 22a than on the other support structure 22b, thus allowing an electrical current to flow through the filament 11. The support structures can be a shape that allows easy placement into the equipment where the planar filament will be used.

The support structure can be attached to a support base 23 for additional structural strength and to aid in handling and placement of the planar filament. This support base can have high electrical resistance in order to electrically isolate one support structure and thus also one bond pad from the other. The support structures can be mounted onto the support base with an adhesive, by pushing the support structures into holes in the support base, with fasteners such as screws, or other appropriate fastening method.

The filament 11 and bond pad 12a and 12b shapes may be formed by laser machining a layer 14 of material that is suitable for filaments and bond pads. The layer 14, and thus the filament 11 and/or bonding pads 12a and 12b, can be a flat layer with planar top and bottom surfaces that are parallel with respect to one another, and with a constant thickness (orthogonal to the top surface of the substrate). A laser can cut the material out of the layer 14 to create the filament 11 and bond pad 12 shapes. Alternately, the filament and bond pad shapes can be made by photolithography techniques. The layer 14 can be coated with photo-resist, exposed to create the desired pattern, then etched. These methods of making the filament 11 and bond pad 12a and 12b shapes apply to all embodiments of the planar filament discussed in this application. These methods also apply to making the beam shaping pads discussed later. Forming the filament and bond pad structure through laser machining or forming the filament and bond pad structure through photolithography techniques may be referred to herein as “patterned” or “patterning”.

The layer 14 can be laser welded onto the support structures 22a and 22b. The support structures 22a and 22b can hold the layer 14 in place while cutting out the filament 11 and bond pads 12a and 12b as discussed previously. Alternatively, the bond pads 12a and 12b can be laser welded onto the support structures 22a and 22b after the bond pads 12a and 12b and filament 11 have been cut.

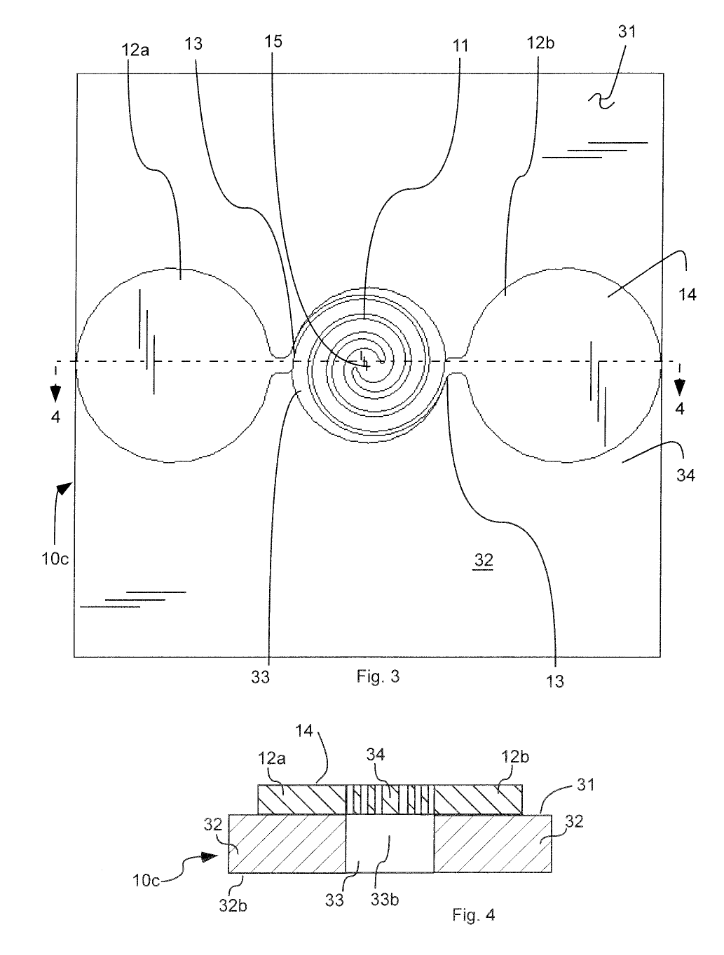

Referring now to FIGS. 3 and 4, a planar filament 10c, in accordance with another embodiment of the present invention is shown. The planar filament 10c includes a layer 14 disposed over a top surface 31 of a substrate 32. The substrate can be a heat resistive, electrically insulating material, such as alumina or silicon. The layer 14 can be mounted to the substrate by brazing or by laser welding. The substrate can aid in handling the planar filament without damage and placing it consistently in the desired equipment location.

A space 33 can be disposed between the filament 11 and the substrate 32 such that a substantial portion of the filament, such as all or a majority of the filament, is suspended above the substrate by the pair of boding pads. The space 33 beneath the filament 11 can be an open area such as a vacuum, air, or other gas. The substrate can be wholly or partially removed beneath the filament forming a recess or cavity 33b bounded by the substrate on the sides (and possibly the bottom) with the filament on top. Alternatively, a hole or opening can be made in the substrate, from the top surface of the substrate to the bottom surface, so that no substrate material is beneath the filament. Alternatively, a channel could also be created in the substrate beneath the filament and then replacing removed substrate with a different material. High filament temperatures are normally needed for electron emission in an x-ray tube. To avoid conductive heat transfer away from the filament, the substrate can be removed beneath most of the filament area.

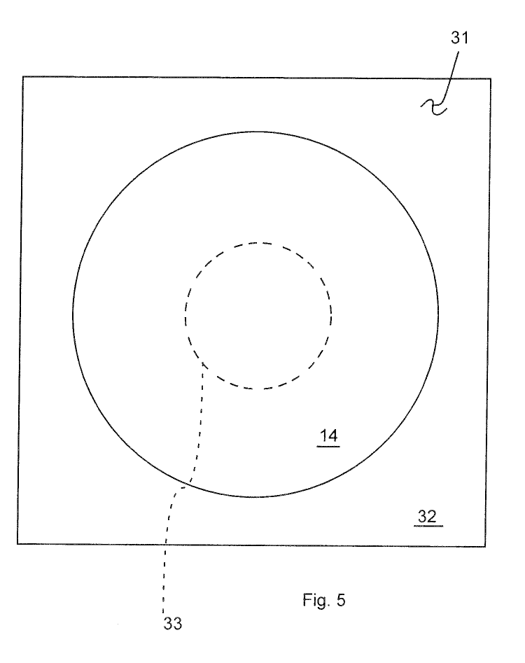

To make a planar filament with a substrate 32, such as the planar filament 10c shown in FIG. 3, a layer 14 can be brazed onto a substrate 32 as shown in FIG. 5. Prior to brazing the layer 14, a cavity 33 can be cut in the substrate 32. With the layer 14 held securely in place by the substrate, the bond pad 12 and filament 11 shapes can be cut out by laser machining or patterning and etching as described previously. This method of manufacturing also applies to other embodiments discussed below in which a substrate is used.

The following discussion will cover different exemplary embodiments with various filament 11 shapes and with beam shaping pads. The figures accompanying the following embodiments show an optional substrate 32. The different filament shapes and beam shaping pads may also be used in an embodiment, such as shown in FIG. 1, in which there is no substrate, or in an embodiment, such as shown in FIG. 2, in which there is an electrically isolated support structure connected to each bonding pad.

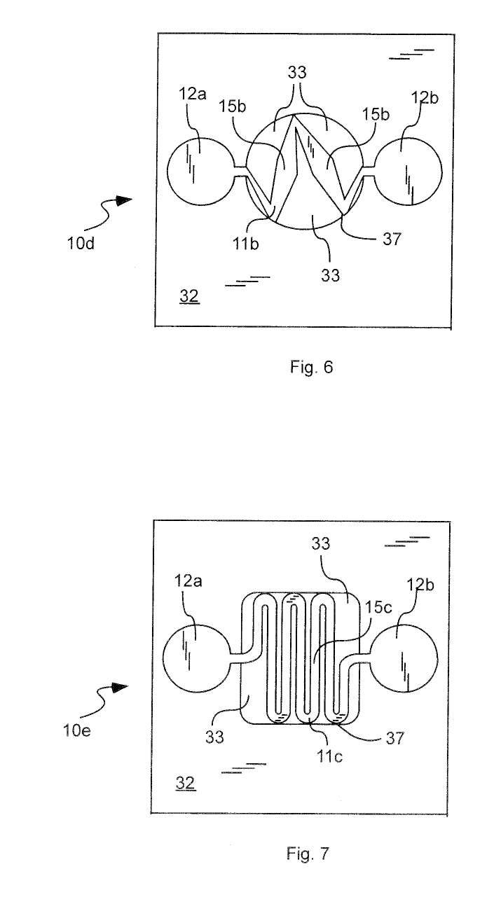

Referring to FIGS. 6 and 7, other planar filaments 10d and 10e in accordance with other exemplary embodiments of the present invention are shown, and which are similar in many respects to that described above (so that the above description is incorporated herein). The filaments 11b and 11c can have a zig-zag or serpentine shape. Intermediate portions 37 of the filament can contact and be carried by the substrate. In addition, the filaments 11b and 11c can have increased width at intermediate portions 15b and 15c (between the ends where the filament touches the substrate). Such increased width is shown in FIG. 6 but not in FIG. 7.

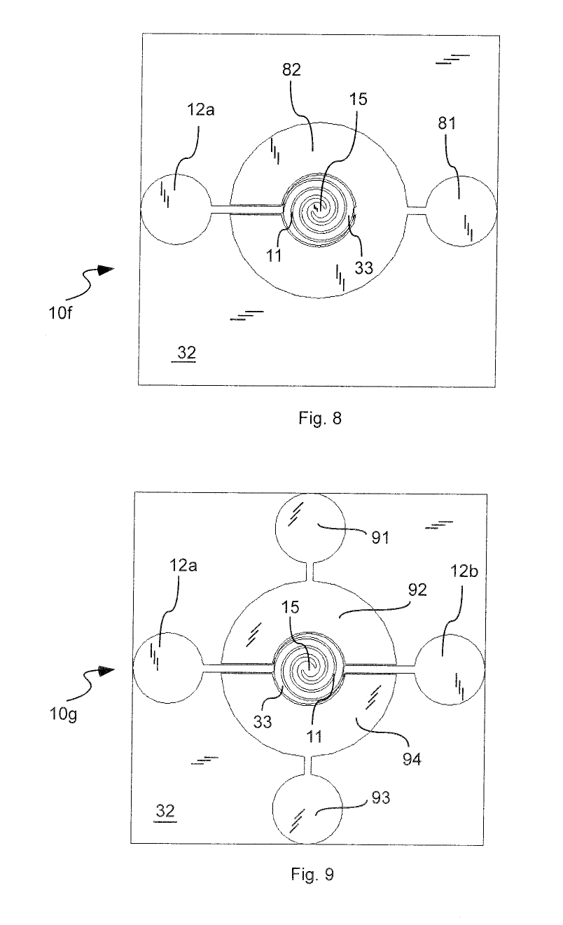

Referring to FIG. 8, another planar filament 10f in accordance with another exemplary embodiment of the present invention is shown, and which is similar in many respects to those described above (so that the above description is incorporated herein). The planar filament 10f can include a beam shaping pad 82 surrounding the filament 11. This beam shaping pad 82 can be at approximately the same voltage as bonding pad 81. This beam shaping pad can affect the shape of the beam. The beam shaping pad can be patterned in the layer along with the bonding pads and filament. In addition, the beam shaping pad can be sized and shaped to substantially surround the filament, as shown. Alternatively, one beam shaping pad could be connected to one bonding pad and another beam shaping pad could be connected to the other bonding pad. The electrical potential of beam shaping pads in this and in later embodiments can aid in improving or directing the shape and location of the electron spot.

Referring to FIG. 9, another planar filament 10g in accordance with another exemplary embodiment of the present invention is shown, and which is similar in many respects to those described above (so that the above description is incorporated herein). The planar filament 10g includes two beam shaping pads 92 and 94 with their own bonding pads 91 and 93 separate from the bonding pads 12a and 12b of the filament 11. The beam shaping pads 92 and 94 can be located on opposite sides of the filament and between the bonding pads 12a and 12b of the filament. These two beam shaping pads 92 and 94 can both be at the same potential or one can be different from the other. They can both be at a more negative or more positive potential than either of bonding pads 12a and 12b of the filament, or they could be the same potential as one of the bonding pads of the filament. At least one of the beam shaping pads could be an electrical potential that is more positive than one of the bonding pads of the filament, and more negative than another bonding pad of the filament. Alternatively, one could be more positive than the bonding pads 12a and 12b of the filament, and the other more negative than the bonding pads 12a and 12b of the filament. A more positive beam shaping pad potential can result in the electron beam being directed away from that side. A more negative beam shaping pad potential can result in the electron beam being drawn towards that side. Use of beam shaping pads can result in improved control of electron spot location, size, and shape.

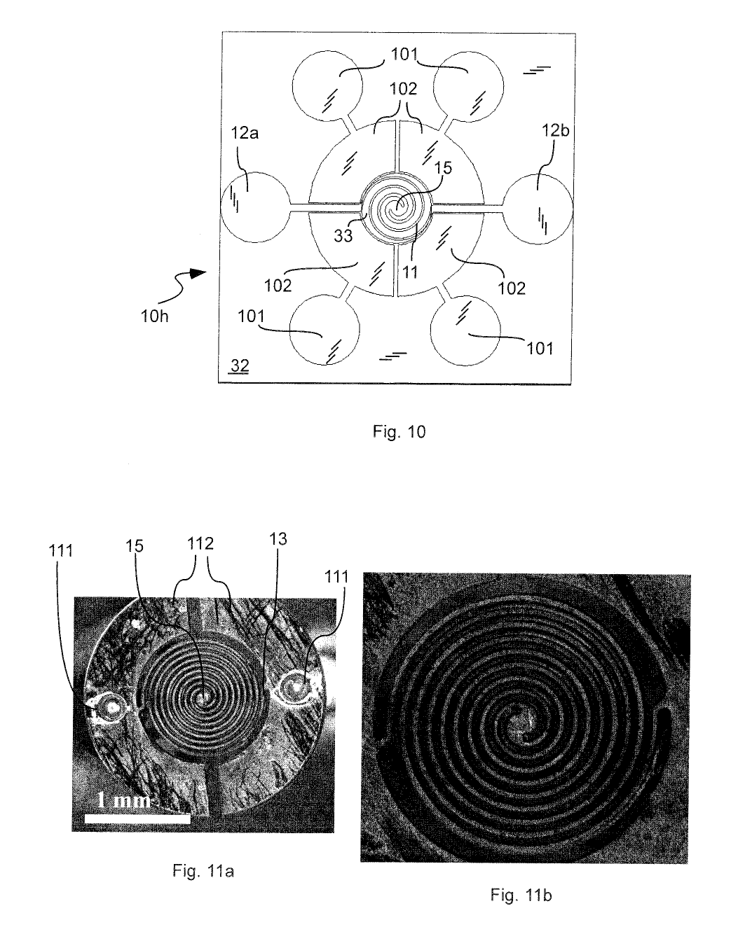

Referring to FIG. 10, another planar filament 10h in accordance with another exemplary embodiment of the present invention is shown, and which is similar in many respects to those described above (so that the above description is incorporated herein). The planar filament 10h includes multiple (such as four) beam shaping pads 102. Each beam shaping pad 102 can be connected to a bonding pad 101. Although not shown in any drawing, there could be three or there could be five or more beam shaping pads, depending on the desired effect on the electron beam. The beam shaping pads could also be many different shapes, different from the shapes shown in the drawings.

FIGS. 11a and 11b show photographs of a planar filament. The planar filament in these figures was made without a substrate and has a spiral shape, similar to the planar filament 10 of FIG. 1. The location 111 on the bond pads, where the bond pads were laser welded to the support structures, are shown. Note that two beam shaping pads 112 are also shown.

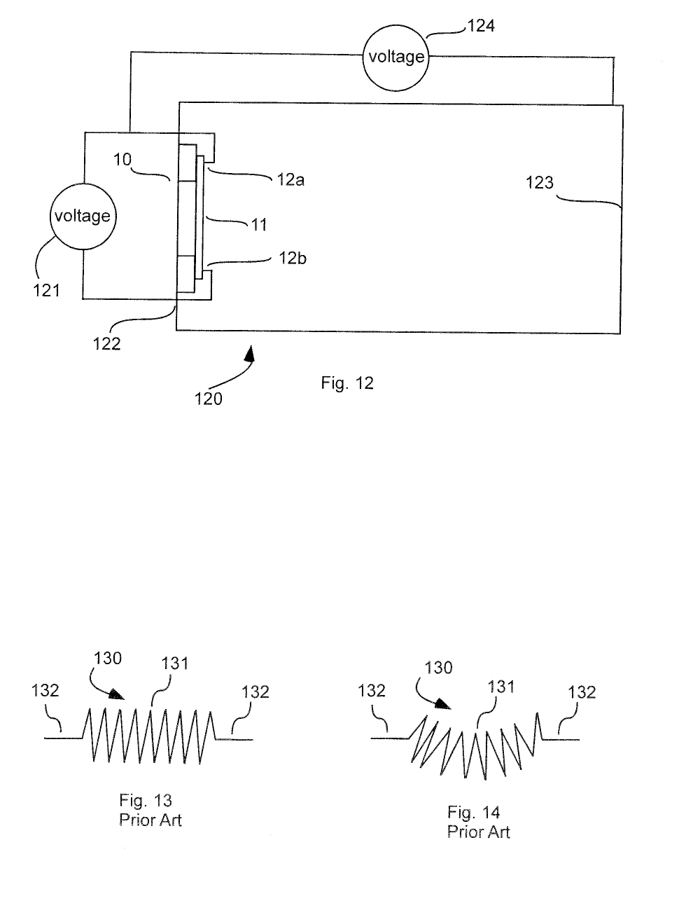

Referring to FIG. 12, an x-ray tube 120 is shown utilizing a planar filament, such as planar filament 10, in accordance with an exemplary embodiment of the present invention. The x-ray tube 120 can include a vacuum tube or vacuum enclosure including opposing cathode 122 and anode 123. The planar filament 10 can be adhered to a cathode 122. Electrical connections can be made to the bonding pads 12a and 12b to allow an electrical current to flow through the filament 11 from a power source 121. The filament 11 can be a large negative bias voltage compared to the anode 123. The large negative bias voltage can be supplied by a high voltage power supply 124. The electrical current in the filament 11 can heat the filament, resulting in electron emission from the filament. The large bias voltage between the anode 123 and the filament 11 can result in an electron beam from the filament to the anode. Due to the planar shape of the filament in the present invention, the electron spot on the anode can be smaller and more circular than with helical filaments. A filament with a substrate or support structure can be more easily placed in the same location in each x-ray tube that is manufactured, resulting in less manufacturing variation. Various aspects of x-ray tubes are shown and described in U.S. Pat. No. 7,382,862; and U.S. patent application Ser. No. 11/879,970, filed Jul. 18, 2007; which are herein incorporated by reference.

Although the present invention has been described above and illustrated with bonding pads that are large relative to the filament, it will be appreciated that the bonding pads can be smaller, and/or can be configured for any type of electrical connection to the power source.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A planar filament device, comprising:
a) a layer patterned to form:
i) a pair of spaced-apart bonding pads each configured to receive an electrical connection; and
ii) a filament connected between the pair of bonding pads configured to receive an applied electric current therethrough; and
b) the filament having a non-uniform width measured in a plane of the layer and transverse to a length of the filament; and
c) the filament being wider near an intermediate portion of the filament and narrower at ends of the filament near the pair of bonding pads.

2. A device as in claim 1, wherein the filament has a double spiral shape oriented parallel to the layer.

3. A device as in claim 1, further comprising at least one beam shaping pad also patterned in and defined by the layer, and disposed adjacent to and spaced-apart from the filament.

4. A device as in claim 1, further comprising:
a) at least two beam shaping pads patterned in and defined by the layer; and
b) each of the at least two beam shaping pads being electrically connected to the pair of bonding pads.

5. A device as in claim 1, further comprising:
a) a beam shaping pad patterned in and defined by the layer and electrically connected to one of the pair of bonding pads; and
b) the beam shaping pad substantially surrounding the filament in a plane of the layer.

6. A device as in claim 1, further comprising:
a) a vacuum enclosure disposed about the filament; and
b) an electrical power source connected to the bonding pads to apply the electric current through the filament to cause the filament to release electrons.

7. A device as in claim 1, wherein support structures support each of the bonding pads and the support structures are electrically isolated from each other.

8. A device as in claim 7, wherein the support structures are connected to an electrically resistant support base.

9. A planar filament device, comprising:
a) a layer patterned to form:
i) a pair of spaced-apart bonding pads each configured to receive an electrical connection; and
ii) a filament connected between the pair of bonding pads configured to receive an applied electric current therethrough; and
b) the filament being suspended between the bonding pads without any other contacting structure on a bottom surface thereof;
c) the filament being flat with planar top and bottom surfaces that are substantially parallel with respect to one another;
d) the filament having a nonuniform width measured in a plane of the layer and transverse to a length of the filament;
e) the filament being wider near an intermediate portion of the filament and narrower at ends of the filament near the pair of bonding pads;
f) the filament extending non-linearly between the pair of bonding pads; and
h) electrically isolated support structures supporting each of the bonding pads.

10. A device as in claim 9, further comprising:
a) a vacuum enclosure disposed about the planar filament;
b) a cathode coupled to the vacuum enclosure;
c) an anode coupled to the vacuum enclosure and opposing the cathode; and
d) a power source electrically coupled to the pair of bonding pads to apply the electric current through the filament to cause the filament to release electrons, and a high voltage power supply being electrically coupled to the cathode and the anode to form a voltage differential therebetween to cause the electrons to accelerate to the anode.

11. A planar filament device, comprising:
a) a substrate with a top surface;
b) a layer disposed over the top surface of the substrate and patterned to form:
i) a pair of spaced-apart bonding pads each configured to receive an electrical connection; and
ii) a filament connected between the pair of bonding pads configured to receive an applied electric current therethrough.

12. A device as in claim 11, wherein the filament has a double spiral shape oriented parallel to the layer.

13. A device as in claim 11, wherein the filament has a non-uniform width measured in a plane of the layer and transverse to a length of the filament.

14. A device as in claim 11, wherein the filament is wider near an intermediate portion of the filament and narrower ar ends of the filament near the pair of bonding pads.

15. A device as in claim 11, further comprising at least one beam shaping pad also patterned in and defined by the layer, and disposed adjacent and spaced-apart from the fi lament.

16. A device as in claim 11, further comprising:
a) at least two beam shaping pads patterned in and defined by the layer; and
b) each of the at least two beam shaping pads being electrically connected to the pair of bonding pads.

17. A device as in claim 11, further comprising:
a) a beam shaping pad patterned in and defined by the layer and electrically connected to one of the pair of bonding pads; and
b) the beam shaping pad substantially surrounding the filament in a plane of the layer.

18. A device as in claim 11, further comprising:
a) a vacuum enclosure disposed about the filament; and
b) an electrical power source connected to the bonding pads to apply the electric current through the filament to cause the filament to release electrons.

19. A planar filament device, comprising:
a) a substrate with a top surface;
b) a layer disposed over the top surface of the substrate and patterned to form:
i) a pair of spaced-apart bonding pads each configured to receive an electrical connection; and
ii) a filament connected between the pair of bonding pads configured to receive an applied electric current therethrough; and
c) the filament being suspended between the bonding pads without any other contacting structure on a bottom surface thereof;
d) the filament having a non-uniform width measured in a plane of the layer and transverse to a length of the filament;
e) the filament being wider near an intermediate portion of the filament and narrower at ends of the filament near the pair of bonding pads; and
f) the filament extending non-linearly between the pair of bonding pads.

20. A device as in claim 19, further comprising:
a) a vacuum enclosure disposed about the filament; and
b) an electrical power source connected to the bonding pads to apply the electric current through the filament to cause the filament to release electrons.
c) a cathode coupled to the vacuum enclosure;
d) an anode coupled to the vacuum enclosure and opposing the cathode; and
e) the filament being associated with the cathode.
